(19) United States
(12) Patent Application Publication
(10) Pub. No.: US 2008/0126839 A1
(43) Pub. Date: May 29, 2008

(54) Optimized reconstruction and copyback methodology for a failed drive in the presence of a global hot spare disc

(76) Inventors: Satish Sangapu, Wichita, KS (US); Kevin Kidney, Lafayette, CO (US); Kurt Denton, Wichita, KS (US); Dianna Butter, Erie, CO (US)

Correspondence Address: LSI CORPORATION, 1621 BARBER LANE, MS: D-106, MILPITAS, CA, 95035, US

(21) Appl. No.: 11/523,452

(22) Filed: Sep. 19, 2006

(51) Int. Cl. G06F 11/20; G06F 12/06

(52) U.S. Cl. 714/5; 711/114; 711/E12.103; 714/E11.084

(57) ABSTRACT

The present invention is a system for optimizing the reconstruction and copyback of data contained on a failed disk in a multi-disk mass storage system.

A system in accordance with the present invention may comprise the following: a processing unit requiring mass-storage; one or more disks configured as a RAID system; an associated global hot spare disk; and interconnections linking the processing unit, the RAID and the global hot spare disk.

In a further aspect of the present invention, a method for the reconstruction and copyback of a failed disk volume utilizing a global hot spare disk is disclosed. The method includes: detecting the failure of a RAID component disk; reconstructing a portion of the data contained on the failed RAID component disk to a global hot spare disk; replacing the failed RAID component disk; reconstructing any data on the failed RAID disk not already reconstructed to the global hot spare disk to the replacement disk; and copying any reconstructed data from the global hot spare disk back to the replacement RAID component disk.

### FIELD OF THE INVENTION

The present invention relates to the field of Redundant Arrays of Inexpensive Disks (RAID) storage systems and, more particularly, optimizing the reconstruction of the contents of a component drive in a RAID system following its failure.

### BACKGROUND OF THE INVENTION

Redundant Arrays of Inexpensive Disks (RAID) have become effective tools for maintaining data within current computer system architectures. A RAID system utilizes an array of small, inexpensive hard disks capable of replicating or sharing data among the various drives. A detailed description of the different RAID levels is disclosed by Patterson, et al. in “A Case for Redundant Arrays of Inexpensive Disks (RAID),” ACM SIGMOD Conference, June 1988. This article is incorporated by reference herein.

Several different levels of RAID implementation exist. The simplest array, RAID level 1, comprises one or more primary disks for data storage and an equal number of additional “mirror” disks for storing a copy of all the information contained on the data disks. The remaining RAID levels 2, 3, 4, 5 and 6, all divide contiguous data into pieces for storage across the various disks.

RAID level 2, 3, 4, 5 or 6 systems distribute this data across the various disks in blocks. A block is composed of multiple consecutive sectors. A sector is the disk drive's minimal unit of data transfer. A sector is a physical section of a disk drive and comprises a collection of bytes. When a data block is written to a disk, it is assigned a Disk Block Number (DBN). All RAID disks maintain the same DBN system so one block on each disk will have a given DBN. A collection of blocks across the various disks which have the same DBN are collectively known as stripes.

Additionally, many of today's operating systems manage the allocation of space on mass storage devices by partitioning this space into volumes. The term volume refers to a logical grouping of physical storage space elements which are spread across multiple disks and associated disk drives, as in a RAID system. Volumes are part of an abstraction which permits a logical view of storage as opposed to a physical view of storage. As such, most operating systems see volumes as if they were independent disk drives. Volumes are created and maintained by Volume Management Software. A volume group comprises a collection of distinct volumes that comprise a common set of drives.

One of the major advantages of a RAID system is its ability to reconstruct data from a failed component disk from information contained on the remaining operational disks. In RAID levels 3, 4, 5, 6, redundancy is achieved by the use of parity blocks. The data contained in a parity block of a given stripe is the result of a calculation carried out each time a write occurs to a data block in that stripe. The following equation is commonly used to calculate the next state of a given parity block:

new parity block=(old data block×or new data block)×or old parity block

The storage location of this parity block varies between RAID levels. RAID levels 3 and 4 utilize a specific disk dedicated solely to the storage of parity blocks. RAID levels 5 and 6 interleave the parity blocks across all of the various disks. RAID level 6 distinguishes itself as it has two parity blocks per stripe, thus accounting for the simultaneous failure of two disks. If a given disk in the array fails, the data and parity blocks for a given stripe contained on the remaining disks can be combined to reconstruct the missing data.

One mechanism for dealing with the failure of a single disk in a RAID system is the integration of a global hot spare disk. A global hot spare disk is a disk or group of disks used to replace a failed primary disk in a RAID configuration. The equipment is powered on or considered “hot,” but is not actively functioning in the system. When a single disk in a RAID system (or up to two disks in a RAID 6 system) fails, the global hot spare disk integrates for the failed disk and reconstructs all the volume pieces of the failed disk using the data blocks and parity blocks from the remaining operational disks. Once this data is reconstructed, the global hot spare disk may function as a component disk of the RAID system until a replacement for the failed RAID disk is inserted into the RAID. When the failed primary disk is replaced, a copyback of the reconstructed data from the global hot spare to the replacement disk may occur.

Currently, when component disks in a non-RAID 0 system fail and a replacement for that component disk is inserted into the RAID prior to completion of the reconstruction of all volume pieces from the failed disk, the global hot spare disk remains integrated for the failed disk and the reconstruction of all volume pieces from the failed disk is directed to the global hot spare disk. This approach needlessly reconstructs and copies back volume pieces which had not yet begun the reconstruction process when the replacement drive was inserted.

Therefore, it would be desirable to provide a system and a method for reconstruction and copyback of a failed disk in a RAID using a global hot spare disk where only the volume pieces of the failed disk whose reconstruction had begun prior to insertion of a replacement disk are reconstructed to the global hot spare and the volume pieces whose reconstruction had not yet begun upon replacement of the failed disk are reconstructed directly to the replacement disk.

### SUMMARY OF THE INVENTION

Accordingly, the present invention is directed to a system and a method for optimized reconstruction and copyback of a failed RAID disk utilizing a global hot spare disk.

In a first aspect of the invention, a system for the reconstruction and copyback of a failed RAID disk utilizing a global hot spare is disclosed. The system comprises the following: a processing unit requiring mass-storage; one or more disks configured as a RAID system; an associated global hot spare disk; and interconnections linking the processing unit, the RAID and the global hot spare disk.

In a further aspect of the present invention, a method for the reconstruction and copyback of a failed disk volume utilizing a global hot spare disk is disclosed. The method includes: detecting the failure of a RAID component disk; reconstructing a portion of the data contained on the failed RAID component disk to a global hot spare disk; replacing the failed RAID component disk; reconstructing any data on the failed RAID disk not already reconstructed to the global hot spare disk to the replacement disk; and copying any reconstructed data from the global hot spare disk back to the replacement RAID component disk.

It is to be understood that both the foregoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is an illustrative representation of an n-disk RAID system and an additional standby global hot spare disk. A volume group comprising the n disks has m individual volumes, each volume being segmented into n pieces across the n disks.

FIG. 2 is an illustrative representation of an n-disk RAID system and an additional standby global hot spare disk wherein one of the n disks has failed.

FIG. 3 is an illustrative representation of an I/O request having been issued to at least one volume of a volume group, causing all volumes to transition from an optimal state into a degraded state.

FIG. 4 is an illustrative representation of the integration of a global hot spare disk and the reconstruction of a volume piece of a degraded-state volume from a failed disk onto the global hot spare disk utilizing data and parity information from the volume pieces from the remaining n-1 operational disks still connected in the RAID.

FIG. 5 is an illustrative representation reconstruction of the degraded-state volume pieces of a failed disk to a replacement disk utilizing data and parity information from the remaining n-1 operational disks still connected in the RAID.

FIG. 6 is an illustrative representation of the copyback of a reconstructed volume piece from the global hot spare disk to a replacement disk for a failed disk.

FIG. 7 is a flow diagram illustrating a method for the reconstruction and copyback of a failed disk in a RAID system utilizing a global hot spare disk.

### DETAILED DESCRIPTION OF THE INVENTION

Reference will now be made in detail to the presently preferred embodiments of the invention.

Should a component disk of a RAID system fail, a global hot spare disk will incorporate for the missing drive. Following the disk failure, when a processing unit makes an I/O request to one or more volumes in the RAID, the volumes which have individual volume “pieces” located on that disk transition into a “degraded” state. When one or more volumes become degraded, the system initiates a reconstruction of the degraded-volume pieces on the failed disk to the global hot spare disk so as to maintain the consistency of the data. This reconstruction is achieved by use of the data and parity information maintained on the remaining drives. Following reconstruction of any degraded volumes, the global hot spare disk operates as a component drive in the RAID in place of the failed disk with respect to the degraded volumes. Once a replacement disk for the failed disk is inserted back into the RAID, the degraded-volume pieces which have previously been reconstructed on the global hot spare disk are copied back to the replacement disk.

However, the possibility exists that, during the reconstruction of multiple degraded-volume pieces to the global hot spare disk, a replacement disk may be inserted in place of the failed disk. Should this situation arise, the system begins reconstructing those degraded-volume pieces of the failed disk not already reconstructed to the global hot spare disk directly to the replacement disk.

This methodology shortens the amount of time required for the reconstruction/copyback process as a whole (and thus any overall system down time). A portion of the reconstruction can be carried out directly on the replacement disk, thereby avoiding the time which would be required for copyback of that data from the global hot spare to a replacement disk.

This methodology also reduces the amount of time that a global hot spare is dedicated to a given volume group. As a global hot spare can only be incorporated for one failed RAID component disk at a time, the simultaneous failure of multiple RAID disks can not be handled. As such, minimizing the amount of time that a global hot spare is used as a RAID component disk is desirable.

A system in accordance with the invention may be implemented by incorporation into the volume management software of a processing unit requiring mass-storage, as firmware in a controller for a RAID system, or as a stand alone hardware component which interfaces with a RAID system.

Additional details of the invention are provided in the examples illustrated in the accompanying drawings.

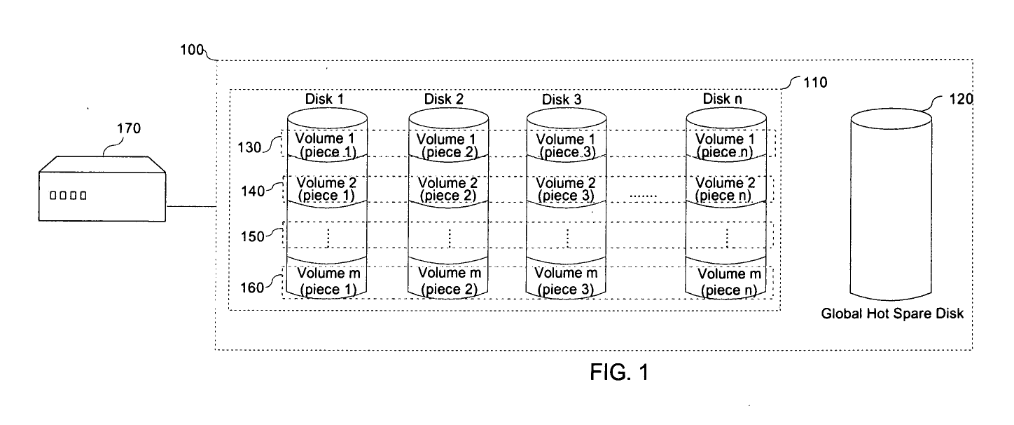

Referring to FIG. 1, an illustrative representation of a mass storage system 100 comprising an n-disk, non-RAID 0 system 110 and an additional standby global hot spare disk 120 is shown. A volume group comprises m individual volumes 130, 140, 150 and 160. Each volume 130, 140, 150 and 160 is comprised of n individual pieces, each corresponding one of the n disks of the n-disk RAID system. Volume management software of an external device capable of transmitting I/O requests 170 enables the device to treat each volume as being an independent disk drive.

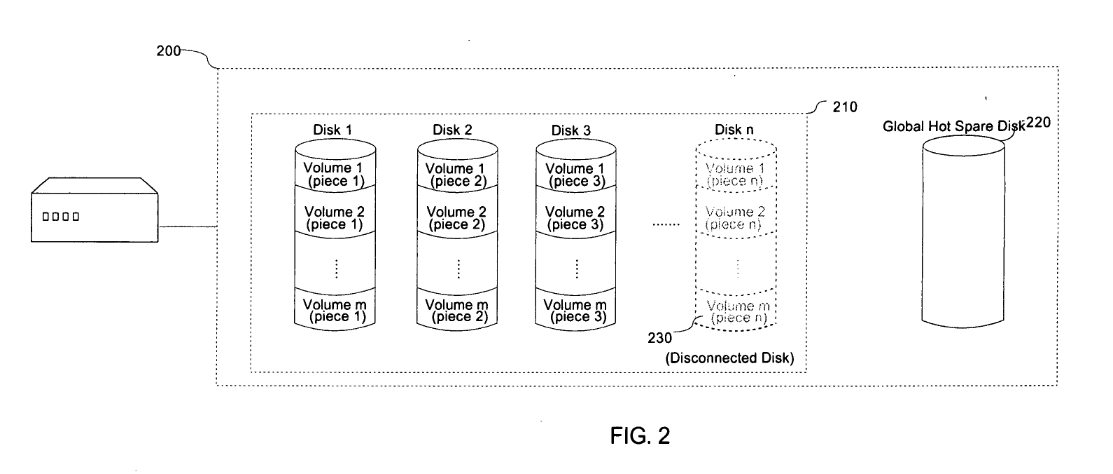

Referring to FIG. 2, an illustrative representation of a mass storage system 200 comprising an n-disk RAID system 210 with an additional standby global hot spare disk 220 is shown, wherein one of the n disks 230 has failed.

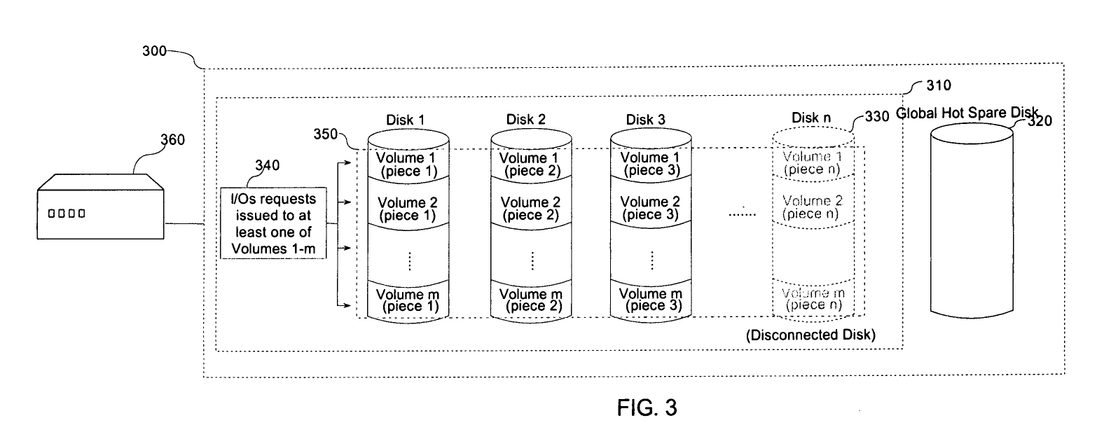

Referring to FIG. 3, an illustrative representation of mass storage system 300 comprising an n-disk RAID system 310 with an additional standby global hot spare disk 320 is shown, wherein one of the n disks has failed 330. An I/O request 340 is made to one or more of the volumes 350 by the CPU 360. When this occurs, the individual volumes 350 transition from an optimal state to a degraded state. This transition initiates the reconstruction of the degraded-state volume pieces located on the failed disk 330 to the global hot spare disk 320.

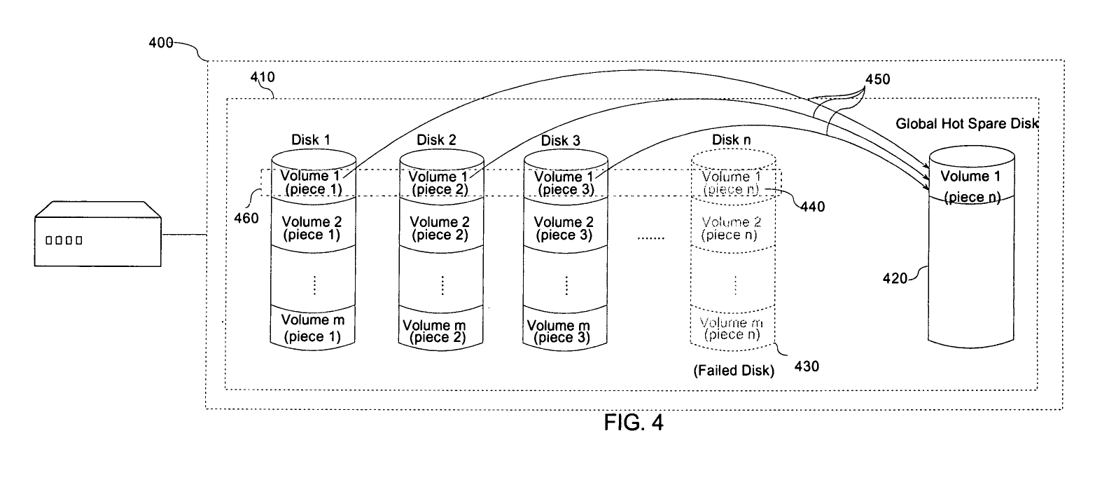

Referring to FIG. 4, an illustrative representation of a mass storage system 400 comprising an n-disk RAID system 410 with an additional standby global hot spare disk 420 is shown, wherein one of the n disks 430 has failed. The global hot spare disk 420 has been integrated as a component disk of the n-disk RAID system 410. The volume piece 440 of a degraded-state volume 460 located on the failed disk 430 is reconstructed onto the global hot spare disk 420 utilizing the existing data blocks and parity blocks 450 from the remainder of the degraded volumes 460 of the operational disks.

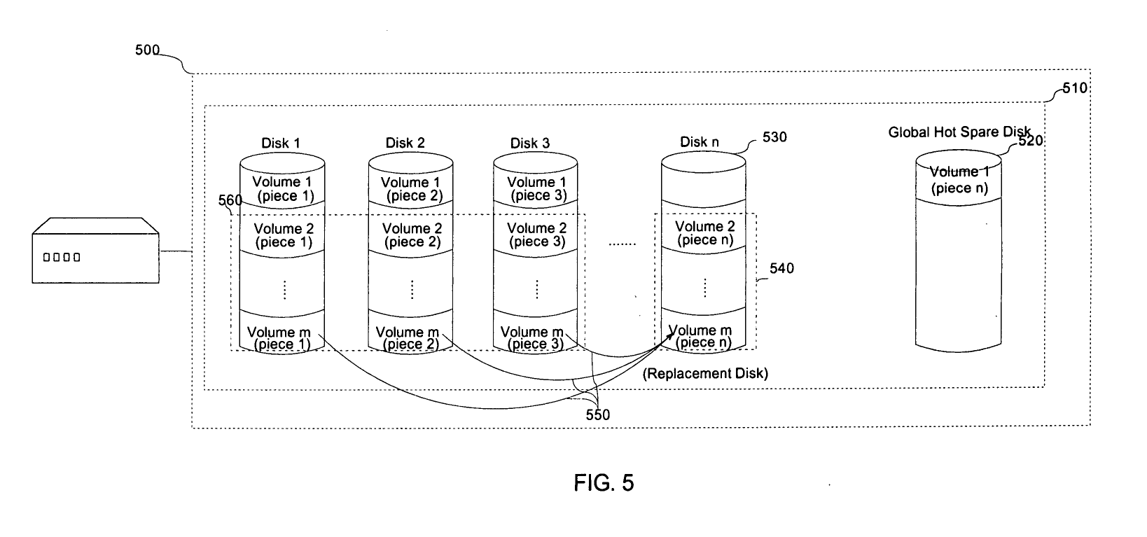

Referring to FIG. 5, an illustrative representation of a of mass storage system 500 comprising an n-disk RAID system 510 with an additional standby global hot spare disk 520 is shown, wherein a previously failed disk has been substituted with a replacement disk 530. The volume pieces 540 corresponding to the degraded-state volume pieces contained on the failed disk are reconstructed onto the replacement disk utilizing the existing data blocks and parity blocks 550 from the remainder of the degraded volumes 560 of the operational disks.

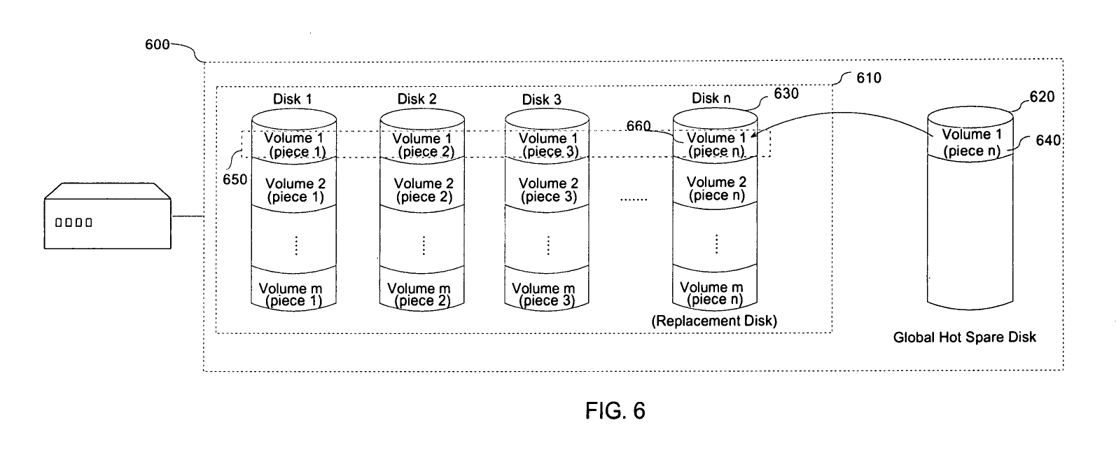

Referring to FIG. 6, an illustrative representation of a of mass storage system 600 comprising an n-disk RAID system 610 with an additional standby global hot spare disk 620 is shown, wherein a previously failed disk has been substituted with a replacement disk 630. The volume piece 640 of a degraded volume 650 previously reconstructed on the global hot spared disk 620 is copied back from the global hot spare disk 620 to the corresponding volume piece 660 of the replacement RAID disk 630.

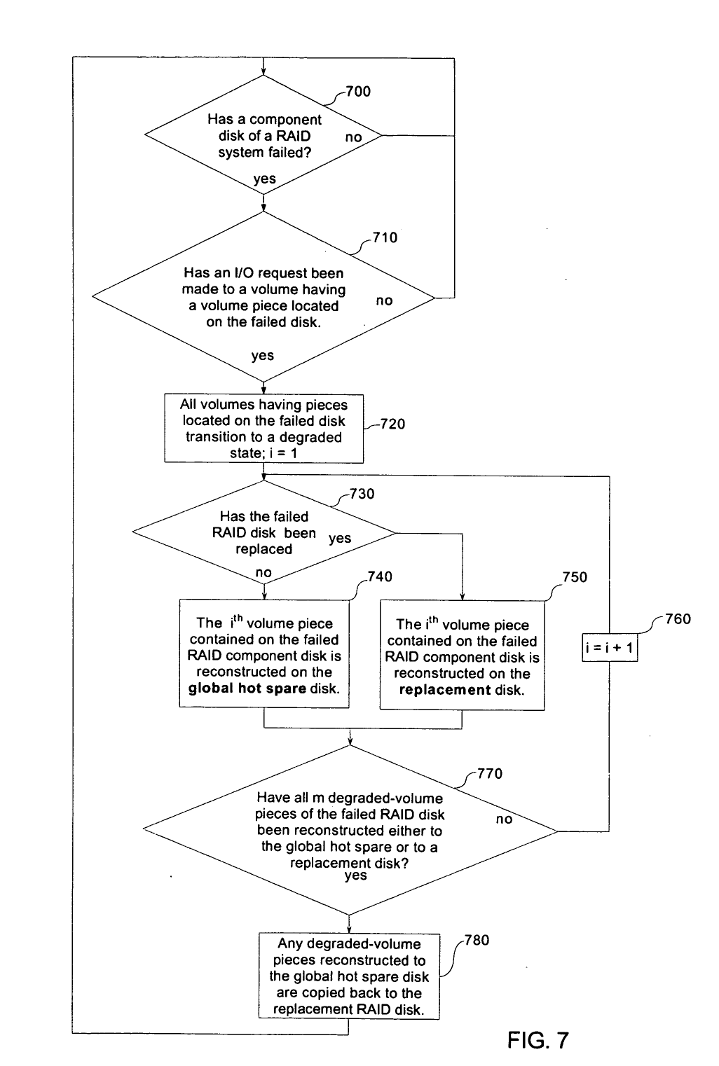

Referring to FIG. 7, a flowchart detailing a method for the reconstruction and copyback of a failed disk in a RAID system utilizing a global hot spare disk is shown. Once the failure of a RAID disk has been detected 700, a stand-by global hot spare drive may be incorporated to account for the missing RAID disk. Should an external device capable of transmitting I/O requests, such as a CPU, issue an I/O request to a volume having a volume piece located on the failed disk 710, all volumes having volume pieces on the failed disk transition to a degraded state 720. Such a transition triggers the reconstruction of the volume pieces of the failed disk. The destination of the reconstructed data is dependent on whether or not a replacement disk has been inserted in place of the failed disk. If a replacement disk is not present, the i^{th} degraded volume piece is reconstructed to the global hot spare 740. If the reconstruction occurs such that all degraded volumes are reconstructed to the global hot spare disk and the failed RAID disk has not been replaced, the global hot spare disk continues to operate in place of the failed disk with respect to the degraded volumes until the failed disk is replaced. However, if a replacement disk is inserted 730 at any point during the reconstruction process, the remaining degraded volume pieces are reconstructed to the replacement disk 750 and not to the global hot spare disk 740. The reconstruction process continues 760 until each of the each of the m volumes has been reconstructed 770 to either the global hot spare disk or the replacement disk. Following the reconstruction of all degraded volume pieces and replacement of the failed disk, those volume pieces which were reconstructed to the global hot spare disk are copied back to the replacement disk 780.

It is believed that the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof. It is the intention of the following claims to encompass and include such changes.

What is claimed is:

1. A data storage system, the system comprising:
An external device requiring mass storage;
an n-disk redundant array of inexpensive disks (RAID);
a global hot spare disk; and
interconnections linking the external device, the RAID, and the global hot spare disk,
wherein physical storage space of the n-disk RAID is partitioned into m logical volumes,
wherein data comprising each of the m logical volumes is distributed as separate pieces across the n disks, and
wherein each of the n disks are replaceable upon failure.

2. The data storage system of claim 1,
wherein one of the n disks fails.

3. The data storage system of claim 2,
wherein an input or output (I/O) request from the external device accesses or modifies one or more logical volumes of the n-disk RAID.

4. The data storage system of claim 3,
wherein the pieces of the accessed or modified logical volumes located on the disconnected disk are reconstructed.

5. The data storage system of claim 4,
wherein the destination of the reconstruction is the global hot spare disk if a replacement disk for the failed disk has not been inserted into the RAID.

6. The data storage system of claim 5,
wherein the global hot spare disk operates as a component disk in the n-disk RAID with respect to the reconstructed logical volume pieces until the failed disk is replaced.

7. The data storage system of claim 6,
wherein the reconstructed logical volume pieces are copied back to the disconnected disk when it is reconnected.

8. The data storage system of claim 4,
wherein the destination of the reconstruction is a replacement disk for the failed disk if the replacement disk has been inserted into the RAID.

9. The data storage system of claim 4,
wherein the reconstruction occurs through use of existing data blocks and parity blocks from the remaining n-1 operational disks in the n-disk RAID.

10. A method for reconstructing the contents of a failed disk in an n-disk redundant array of inexpensive disks (RAID), the method comprising:
detecting the failure of one n disks of an n-disk RAID;
receiving one or more input signals from an external device;
transitioning all volumes to a degraded state;
reconstructing degraded-state volumes pieces of the failed disk to either a global hot spare disk or a replacement disk for the failed disk;
replacing the failed disk in the n-disk RAID;
copying the volume pieces reconstructed on the global hot spare disk back to the replacement disk.

11. The method of claim 10,
wherein the input signal is a request to access or modify data located in one or more logical volumes;

12. The method of claim 11,
wherein the transitioning of the logical volumes from an optimal state to a degraded state occurs when contents of one or more of the logical volumes are accessed or modified.

13. The method of claim 10,
wherein the destination of the reconstructed degraded-state volume pieces is the global hot spare if the failed disk has not been replaced.

14. The method of claim 13,
wherein the global hot spare disk operates as a component disk in the n-disk RAID with respect to the reconstructed degraded-state logical volume pieces if the failed disk has not been replaced.

15. The method of claim 14,
wherein the reconstructed degraded-state volume pieces are copied to the reconnected disk.

16. The method of claim 10,
wherein the destination of the reconstructed degraded-state volume pieces is the global hot spare if the failed disk has been replaced.

17. The method of claim 10, wherein the reconstruction occurs through use of existing data blocks and parity blocks from the remaining n-1 operational disks in the n-disk RAID.

18. A computer-readable medium having computer readable instructions stored thereon for execution by a processor to perform a method, the method comprising:
detecting disconnection of one of n disks of an n-disk RAID;
receiving an input signal from an external device;
transitioning one or more logical volumes from an optimal state to a degraded state;
reconstructing degraded-state logical volume pieces of the disconnected disk on a global hot spare disk;
reconnecting the disconnected disk;
copying the volumes pieces reconstructed on the global hot spare disk to the reconnected disk in the n-disk RAID.

19. The computer-readable medium of claim 18,
wherein the input signal is a request to access or modify data located in one or more logical volumes;

20. The computer-readable medium of claim 19,
wherein the transitioning of the logical volumes from an optimal state to a degraded state occurs when contents of one or more of the logical volumes are accessed or modified.

21. The computer-readable medium of claim 18,
wherein the destination of the reconstructed degraded-state volume pieces is the global hot spare if the failed disk has not been replaced.

22. The computer-readable medium of claim 21,
wherein the global hot spare disk operates as a component disk in the n-disk RAID with respect to the reconstructed degraded-state logical volume pieces if the failed disk has not been replaced.

23. The computer-readable medium of claim 22,
wherein the reconstructed degraded-state volume pieces are copied to the reconnected disk.

24. The computer-readable medium of claim 18,
wherein the destination of the reconstructed degraded-state volume pieces is the global hot spare if the failed disk has been replaced.

25. The computer-readable medium of claim 18,
wherein the reconstruction occurs through use of existing data blocks and parity blocks from the remaining n-1 operational disks in the n-disk RAID.
